(19) United States
(12) Patent Application Publication
(10) Pub. No.: US 2025/0292342 A1
(43) Pub. Date: Sep. 18, 2025

(54) Autonomous Real Estate Investment and Development Platform with Integrated Risk Management and Insurance Framework

(71) Applicant: Zohar Dor Lavi, Zurich (CH)

(72) Inventor: Zohar Dor Lavi, Zurich (CH)

(21) Appl. No.: 19/047,727

(22) Filed: Feb. 7, 2025

Related U.S. Application Data
(60) Provisional application No. 63/565,591, filed on Mar. 15, 2024.

(51) Int. Cl. G06Q 50/163; G06Q 40/08; G06Q 50/08; H04L 9/00

(52) U.S. Cl. CPC G06Q 50/163; G06Q 40/08; G06Q 50/08; H04L 9/50

(57) ABSTRACT

The present invention relates to a computer-implemented platform and method for managing real estate investment and development projects. The platform integrates artificial intelligence (AI), blockchain, Internet of Things (IoT), and dynamic insurance services to optimize the execution and management of real estate projects. The platform comprises several key modules: an AI-based risk analysis module for predictive modeling of project risks, a blockchain module for automating milestone-based payments via smart contracts, an IoT module for real-time construction monitoring, an insurance module for dynamically adjusting project-specific insurance policies, and a transaction module for facilitating direct and secure transactions between buyers, investors, and property owners. The platform enhances transparency, reduces transaction costs, and offers flexible financing options by utilizing insurance policies as collateral. This integrated solution improves project efficiency, mitigates risks, and ensures secure, automated execution of real estate transactions.

### I. OVERVIEW OF THE INVENTION

The present invention relates to a computer-implemented platform and method for managing real estate investment and development projects. The platform integrates artificial intelligence (AI), blockchain, the Internet of Things (IoT), and dynamic insurance services to enhance project execution, mitigate risks, and streamline transactions.

The invention addresses common real estate development challenges such as project delays, cost overruns, inefficient financing, and a lack of transparency by providing automated risk assessment, milestone-based payment execution, real-time construction monitoring, and adaptive insurance solutions.

The platform consists of several core functional modules, each performing specific tasks that contribute to a seamless, efficient, and secure real estate investment and development process. These modules include:
A risk analysis module utilizing AI for predictive modeling of project risks;
A blockchain module for executing smart contract-based milestone payments;
A construction monitoring module incorporating IoT devices for real-time data collection;
An insurance module for dynamically adjusting project-specific insurance policies; and
A transaction module for enabling secure, direct transactions between property owners, investors, and buyers.

The described modules work in conjunction to ensure that project execution is optimized, risks are proactively managed, transactions are automated securely, and financing is facilitated through dynamic insurance policies that serve as collateral.

### II. RISK ANALYSIS MODULE (AI-BASED)

The AI-based risk analysis module is designed to process historical and real-time project data to identify risks, predict delays, and optimize project management decisions. The module leverages machine learning techniques, such as regression analysis and deep neural networks, to assess multiple factors, including:
Historical construction project data to identify patterns and common risks;
Real-time construction data, including budget tracking and resource allocation;
Market trends affecting real estate demand and pricing fluctuations;
Environmental conditions that may impact project execution; and
Evolving regulatory requirements that could affect project timelines.

By continuously monitoring and analyzing these data sources, the AI module dynamically updates project risk assessments and provides predictive insights that allow stakeholders to implement proactive risk mitigation strategies.

### III. BLOCKCHAIN MODULE (SMART CONTRACTS FOR PAYMENT AUTOMATION)

The blockchain module securely automates milestone-based payments through smart contracts. Each smart contract defines project milestones and conditions under which payments are released. The smart contracts are executed as follows:
Project milestones are predefined and encoded into the blockchain;
IoT devices verify the completion of milestones and transmit the data to the platform;
Upon verification, the smart contract triggers an automatic payment to the designated party; and
The blockchain ledger maintains an immutable record of all transactions for auditability
   and security.

This module eliminates the need for intermediaries in the payment process, reduces the risk of disputes, and ensures full transparency by providing tamper-proof transaction records.

### IV. CONSTRUCTION MONITORING MODULE (IoT INTEGRATION)

The construction monitoring module integrates IoT devices to collect real-time construction progress data. IoT devices deployed on-site include:
Motion and activity devices for tracking worker productivity;
Environmental devices for assessing temperature, humidity, and other site conditions; and
Site activity devices for verifying completion of scheduled tasks.

These IoT devices continuously transmit real-time data to the platform, allowing for automated milestone verification and reducing reliance on manual inspections. The system ensures that smart contracts are triggered only when milestones are confirmed as completed, improving accuracy and efficiency.

### V. INSURANCE MODULE (DYNAMIC POLICY ADJUSTMENT AND FINANCING SUPPORT)

The insurance module dynamically adjusts project-specific insurance policies based on real-time risk data collected by the AI and IoT modules. Key functionalities of this module include:
Automated risk profile updates as project conditions evolve;
Dynamic insurance policy adjustments to align with changing risk factors; and
The ability to use project-specific insurance policies as collateral to secure financing from traditional financial institutions, non-banking lenders, or private investors.

By integrating real-time data-driven insurance adjustments, this module provides a flexible risk management framework that enhances project security and facilitates alternative financing options.

### VI. TRANSACTION MODULE (SMART CONTRACT-BASED REAL ESTATE TRANSACTIONS)

The transaction module enables direct, secure interactions between property owners, investors, and buyers using blockchain-based smart contracts. This module eliminates the need for intermediaries and ensures:
Direct engagement between stakeholders without third-party involvement;
Secure transactions recorded on the blockchain for transparency and fraud prevention;
   and
Automated execution of transactions via smart contracts, reducing settlement delays and administrative costs.

The integration of blockchain ensures that all property transfers, investment agreements, and payment settlements are immutable, secure, and enforceable.

### VII. METHOD FOR MANAGING REAL ESTATE PROJECTS

The invention further provides a computer-implemented method for managing real estate projects, comprising:
Collecting construction progress data via IoT devices deployed on-site;

Processing the collected data using AI to generate risk assessments and predictive insights;
Executing milestone-based smart contracts for automated payments upon verified project progress;
Dynamically adjusting insurance policies in response to real-time project risks;
Facilitating direct, secure transactions between property owners, buyers, and investors; and
Utilizing dynamically generated insurance policies as collateral for financing.

Each step of the method ensures that the real estate project lifecycle is managed in a data-driven, automated, and risk-mitigated manner, improving overall project efficiency and security.

### VIII. CONCLUSION

The present invention provides an integrated and automated solution for real estate investment and development. By leveraging AI for risk prediction, blockchain for secure transactions, IoT for real-time monitoring, and dynamic insurance for financing support, the platform enhances efficiency, transparency, and security across all project phases.

The invention's ability to facilitate milestone-based payments, automate risk management, and enable direct stakeholder interactions represents a significant advancement in the real estate industry. This technology-driven solution is scalable and adaptable to various real estate project types, making it an innovative tool for improving real estate investment and development processes.

1. Platform for Managing Real Estate Investment and Development A computer-implemented platform for managing real estate investment and development, comprising: a risk analysis module configured to execute artificial intelligence models to process historical project data, real-time project data, market conditions, environmental factors, and regulatory changes to generate risk assessments; a blockchain module configured to generate, store, and execute smart contracts that automate milestone-based payment transactions upon verified completion of predefined project milestones; a construction monitoring module comprising Internet of Things devices configured to capture and transmit real-time construction progress data, including site activity, environmental conditions, and worker productivity, to the platform for milestone verification; an insurance module configured to generate and dynamically adjust project-specific insurance policies in real time based on data from the risk analysis and construction monitoring modules; and a transaction module configured to facilitate secure, automated financial transactions between investors and property owners via blockchain-based smart contracts.

2. Method for Managing Real Estate Development Projects A computer-implemented method for managing real estate development projects, comprising: collecting real-time construction progress data via Internet of Things devices, wherein the data includes site activity, environmental conditions, and worker productivity; analyzing the collected data using artificial intelligence models to identify project risks and generate predictive insights; executing smart contracts on a blockchain to automate milestone-based payments upon verification of milestone completion;
dynamically adjusting project-specific insurance policies in response to real-time project data to reflect evolving risk profiles; facilitating secure, automated financial transactions between investors and property owners through blockchain-based smart contracts; and
enabling the use of dynamically adjusted insurance policies as collateral for securing project financing.

3. Risk Analysis Module Enhancement The platform of claim 1, wherein the risk analysis module utilizes machine learning techniques to analyze historical and real-time project data to improve predictive accuracy.

4. Smart Contract Execution Logic The platform of claim 1, wherein the blockchain module generates smart contracts that define milestone verification conditions and execute financial transactions upon receipt of verified milestone completion data.

5. IoT-Based Construction Monitoring The platform of claim 1, wherein the construction monitoring module includes Internet of Things devices that transmit real-time construction data to the platform for milestone verification.

6. Adaptive Insurance Policies The platform of claim 1, wherein the insurance module dynamically adjusts coverage levels and premiums based on real-time project risk assessments generated by the risk analysis module.

7. Blockchain Transaction Security The platform of claim 1, wherein the transaction module records each transaction on a blockchain using cryptographic verification to ensure security, transparency, and auditability.

8. Insurance as Collateral The platform of claim 1, wherein the insurance module enables dynamically adjusted insurance policies to be used as collateral to secure financing from private lenders, non-bank financial institutions, and traditional financial institutions.
